(19) United States
(12) Patent Application Publication
(10) Pub. No.: US 2015/0187457 A1
(43) Pub. Date: Jul. 2, 2015

(54) Electroconductive Polyamide/Polyphenylene Ether Resin Composition, Method for Preparing the Same and Molded Product for Vehicle Using the Same

(71) Applicant: Samsung SDI Co., Ltd., Yongin-si (KR)

(72) Inventors: Chang Min Hong, Uiwang-si (KR); Doo Young Kim, Uiwang-si (KR); Wonyoung Choi, Uiwang-si (KR); Jung Hun Lee, Uiwang-si (KR); Jin-Kyung Cho, Uiwang-si (KR)

(21) Appl. No.: 14/585,333

(22) Filed: Dec. 30, 2014

(30) Foreign Application Priority Data
Dec. 30, 2013 (KR) 10-2013-0167460

(51) Int. Cl. H01B 1/24

(52) U.S. Cl. CPC H01B 1/24

(57) ABSTRACT

Provided herein is an electroconductive polyamide/polyphenylene ether resin composition, a method for preparing the same, and a molded product for vehicle manufactured using the same. The composition includes a base resin (a) including polyphenylene ether (a-1) and polyamide (a-2); an impact modifier (b); a compatibilizer (c); and an electroconductive filler (d), wherein a pH of the electroconductive filler (d) is about 4 to about 8.

### CROSS-REFERENCE TO RELATED APPLICATION

This application claims the benefit of priority under 35 U.S.C. §119(a) of Korean Patent Application No. 10-2013-0167460, filed on Dec. 30, 2013, in the Korean Intellectual Property Office, the entire disclosure of which is incorporated herein by reference for all purposes.

### 1. FIELD OF INVENTION

Various embodiments of the present invention relate to an electroconductive polyamide/polyphenylene ether resin composition, a method for preparing the same, and a molded product for vehicle manufactured using the same.

### 2. BACKGROUND

Plastic materials have low thermal resistance and flame resistance compared to metal or ceramic materials, but they have advantages such as lightness, design flexibility, and moldability, and thus are widely used in materials for a variety of products, from household items to automobile, electricity, electronics and industrial areas.

There are various types of plastic materials, from commodity plastics to engineering plastics that are being widely used in areas that need various functions and performances.

Of these plastics materials, polyphenylene ether has excellent electrical and mechanical properties, and also a high heat deflection temperature. Thus, polyphenylene ether resins are widely used as engineering plastic materials in various areas.

Polyphenylene ether resin was developed by General Electric Co. in the USA. Based on its excellent thermal resistance, polyphenylene ether resin is becoming a useful industrial material that is mainly used as a blend with high impact polystyrene. More recently, polyphenylene ether resin is employed in the form of alloys, such as polyamide/polyphenylene ether resins compatibilized by a reactive extrusion method, wherein an incompatible blend is compatibilized, and polypropylene/polyphenylene ether resins prepared by adding a compatibilizer as a third substance.

Various disadvantages of polyamide/polyphenylene ether resins have been compensated for effectively, so that the alloys can have a good balance of thermal resistance, impact resistance, and chemical resistance. Thus, polyamide/polyphenylene ether resins are being employed in automobile components such as wheel caps, junction boxes, and under-the-hood components.

Recently, there has been a need for materials that can be used in plastic exterior components by electrostatic online painting simultaneously with other metal material components. See, for example, EP 685527 B1 to General Electric Co., directed to electroconductive polyamide/polyphenylene ether resins used as automobile fender components.

Development of polyamide/polyphenylene resins having electroconductivity enabled electrostratic painting to be performed simultaneously with other metal components, without a need for an additional painting process, thus saving production costs.

As a way to embody electroconductivity in polyamide/polyphenylene ether resins, a method of adding an electroconductive filler such as carbon fiber or carbon black was proposed. See for example, JP H04-300956 A. However, carbon fiber deteriorates the moldability of products, and when using conventional carbon black, carbon black has to be added in large amounts to achieve the electroconductivity necessary for application to electrostatic painting. Either case, it may lead to insufficient impact resistance and moldability.

To resolve the problem of impact resistance and moldability, nano unit carbon fiber (carbon fibril) with adjusted size and electroconductive carbon black have been used, but there occurred a problem of reduced compatibility between polyamide and polyphenylene ether. See for example, JP 2756548 B2.

To resolve the aforementioned problem of reduced compatibility while producing a polyamide/polyphenylene ether resin having excellent properties, it is important that a compatibilization reaction is proceeded smoothly between polyphenylene ether, polyamide, and a compatibilizer.

In this regard, a conventional method of compatibilizing polyamide and polyphenylene ether first, and then adding electroconductive carbon black therein has been disclosed. See for example, EP 685527 B1.

However, according to this method, polyamide/polyphenylene ether resin, compatibilizer and other additives need to be added in a particular adding order using a special extrusion processing equipment with a plurality of side feeders installed therein. This is uneconomical due to high investment costs, and the restrictive order of adding the materials decreases productivity.

Thus, in the present invention, studies were made to provide a polyamide/polyphenylene ether resin composition applicable to online electrostatic painting, having improved properties and economic feasibility, while preserving their excellent intrinsic properties.

### SUMMARY

A purpose of the various embodiments of the present invention is to resolve the aforementioned problems of prior art, that is, to provide an electroconductive polyamide/polyphenylene ether resin composition wherein characteristics of an electroconductive filler are adjusted to improve the impact resistance and electroconductivity of the composition so that the composition may be applied to electrostatic painting, a method for preparing the same, and a molded product for vehicles manufactured using the same.

Another purpose of the various embodiments of the present invention is to provide an electroconductive polyamide/polyphenylene ether resin composition wherein substances constituting the resin composition are adjusted such that without having to mull polyphenylene ether and polyamide first and compatibilize them, even by adding an electroconductive filler to the polyphenylene ether resin composition and melting and mulling the composition prior to compatibilization, the polyamide/polyphenylene ether resin may be provided with excellent impact resistance and electroconductivity, a method for preparing the same, and a molded product for vehicle manufactured using the same.

According to an embodiment of the present invention, there is provided an electroconductive polyamide/polyphenylene ether resin composition including: a base resin (a) including polyphenylene ether (a-1) and polyamide (a-2); an impact modifier (b); a compatibilizer (c); and an electroconductive filler (d), wherein a pH of the electroconductive filler (d) may be about 4 to about 8.

The base resin (a) may include about 10 to about 70 weight % of polyphenylene ether (a-1) and about 30 to about 90 weight % of polyamide (a-2), and about 1 to about 30 parts by weight of impact modifier (b), about 0.2 to about 10 parts by weight of compatibilizer (c), and about 0.1 to about 4.5 parts by weight of electroconductive filler (d), per about 100 parts by weight of the base resin (a).

The electroconductive filler (d) may include at least one of carbon black and carbon fibril.

A pH of the electroconductive filler (d) may be about 4.5 to about 7.5.

The electroconductive polyamide/polyphenylene ether resin composition may comprise the electroconductive filler (d) in an amount of about 0.3 to about 3 parts by weight per about 100 parts by weight of the base resin.

The electroconductive filler (d) may be obtained by a neutralizing or acidifying process.

The polyphenylene ether (a-1) may include: poly(2,6-dimethyl-1,4-phenylene) ether, poly(2,6-diethyl-1,4-phenylene) ether, poly(2,6-dipropyl-1,4-phenylene) ether, poly(2-methyl-6-ethyl-1,4-phenylene) ether, poly(2-methyl-6-propyl-1,4-phenylene) ether, poly(2-ethyl-6-propyl-1,4-phenylene) ether, poly(2,6-diphenyl-1,4-phenylene) ether, a copolymer of poly(2,6-dimethyl-1,4-phenylene) ether and poly(2,3,6-trimethyl-1,4-phenylene) ether, a copolymer of poly(2,6-dimethyl-1,4-phenylene) ether and poly(2,3,6-triethyl-1,4-phenylene) ether or a combination thereof.

The polyamide (a-2) may include: polyamide 6, polyamide 66, polyamide 46, polyamide 11, polyamide 12, polyamide 610, polyamide 612, polyamide 6/66, polyamide 6/612, polyamide MXD6, polyamide 6/MXD6, polyamide 66/MXD6, polyamide 6T, polyamide 61, polyamide 6/6T, polyamide 6/61, polyamide 66/6T, polyamide 66/61, polyamide 6/6T/61, polyamide 66/6T/61, polyamide 9T, polyamide 91, polyamide 6/9T, polyamide 6/91, polyamide 66/9T, polyamide 6/12/9T, polyamide 66/12/61, or a combination thereof.

The impact modifier (b) may include at least one of styrenic elastomer (b-1) and/or olefinic elastomer (b-2).

The styrenic elastomer (b-1) may include: styrene-ethylene-butylene-styrene copolymer, styrene-butadiene-styrene copolymer, styrene-ethylene-propylene-styrene copolymer, styrene-isoprene-styrene copolymer, styrene-ethylene copolymer, styrene-ethylene-butadiene-styrene copolymer, a modified styrene-ethylene-butylene-styrene copolymer, modified styrene-butadiene-styrene copolymer, modified styrene-ethylene-propylene-styrene copolymer, modified styrene-isoprene-styrene copolymer, modified styrene-ethylene copolymer, modified styrene-ethylene-butadiene-styrene copolymer or a combination thereof, wherein each modified copolymer is prepared by modifying the styrene-ethylene-butylene-styrene copolymer, styrene-butadiene-styrene copolymer, styrene-ethylene-propylene-styrene copolymer; styrene-isoprene-styrene copolymer, styrene-ethylene copolymer, and styrene-ethylene-butadiene-styrene copolymer, respectively, with an α,β-unsaturated dicarboxylic acid and/or an α,β-unsaturated dicarboxylic acid derivative.

The olefinic elastomer (b-2) may include: high-density polyethylene, low-density polyethylene, linear low-density polyethylene, ethylene-α-olefin copolymer; modified high-density polyethylene, modified low-density polyethylene, modified linear low-density polyethylene, modified ethylene-α-olefin copolymer or a combination thereof, wherein each modified olefinic elastomer is prepared by modifying the high-density polyethylene, low-density polyethylene, linear low-density polyethylene, and ethylene-α-olefin copolymer, respectively, with an α,β-unsaturated dicarboxylic acid and/or an α,β-unsaturated dicarboxylic acid derivative.

The compatibilizer (c) may include: maleic acid, maleic acid anhydride, maleic acid hydrazide, dichloromaleic acid anhydride, unsaturated dicarboxylic acid, fumaric acid, citric acid, citric acid anhydride, malic acid, agaric acid or a combination thereof.

According to another embodiment of the present invention, there is provided a molded product for vehicles, the product manufactured from the aforementioned electroconductive polyamide/polyphenylene ether resin composition.

According to another embodiment of the present invention, there is provided a method for preparing an electroconductive polyamide/polyphenylene ether resin composition, the method including: preparing an electroconductive polyphenylene ether mixture composition by melting and mulling (mixing) polyphenylene ether (a-1), impact modifier (b), compatibilizer (c) and electroconductive filler (d); forming a polyphenylene ether-polyamide mixture composition by adding polyamide (a-2) to the polyphenylene ether mixture composition; and melting and mulling (mixing) the polyphenylene-polyamide mixture composition.

A pH of the electroconductive filler (d) may be about 4 to about 8.

The electroconductive filler (d) may include at least one of carbon black and/or carbon fibril.

The electroconductive filler (d) may be obtained by a neutralizing or acidifying process.

### DETAILED DESCRIPTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. Also, descriptions of well-known functions and constructions may be omitted for increased clarity and conciseness.

Furthermore, a singular form may include a plural from as long as it is not specifically mentioned in a sentence. Furthermore, “include/comprise” or “including/comprising” used in the specification represents that one or more components, steps, operations, and elements exist or are added.

Furthermore, unless defined otherwise, all the terms used in this specification including technical and scientific terms have the same meanings as would be generally understood by those skilled in the related art. The terms defined in generally used dictionaries should be construed as having the same meanings as would be construed in the context of the related art, and unless clearly defined otherwise in this specification, should not be construed as having idealistic or overly formal meanings.

Hereinafter, an electroconductive polyamide/polyphenylene ether resin composition according to an embodiment of the present invention will be explained in detail.

The polyamide/polyphenylene ether resin composition according to an embodiment of the present invention may be a thermoplastic resin composition including a compatibilized blend of polyphenylene ether and polyamide.

The thermoplastic resin composition may include a base resin (a) including polyphenylene ether (a-1) and polyamide (a-2), impact modifier (b), compatibilizer (c), and electroconductive filler (d).

Herein, a compatibilized blend refers to a composition physically and/or chemically compatibilized with a compatibilizer.

Compatibility refers to the extent to which a substance may be compatibilized. The higher the compatibility, the easier it is to be compatibilized, whereas the lower the compatibility, the more difficult it is to be compatibilized.

Hereinafter, each of the components constituting an electroconductive polyamide/polyphenylene ether resin composition according to an embodiment of the present invention will be explained in detail.

(a) Base Resin

(a-1) Polyphenylene Ether

Examples of the polyphenylene ether (a-1) may include without limitation polyphenylene ether polymers, mixtures of a polyphenylene ether polymer and a vinyl aromatic polymer, modified polyphenylene ether polymers formed by reacting polyphenylene ether polymer with a reactive monomer, and the like, and combinations thereof.

Examples of the polyphenylene ether polymer may include without limitation poly(2,6-dimethyl-1,4-phenylene) ether, poly(2,6-diethyl-1,4-phenylene) ether, poly(2,6-dipropyl-1,4-phenylene) ether, poly(2-methyl-6-ethyl-1,4-phenylene) ether, poly(2-methyl-6-propyl-1,4-phenylene) ether, poly(2-ethyl-6-propyl-1,4-phenylene) ether, poly(2,6-diphenyl-1,4-phenylene) ether, a copolymer of poly(2,6-dimethyl-1,4-phenylene) ether and poly(2,3,6-trimethyl-1,4-phenylene) ether, a copolymer of poly(2,6-dimethyl-1,4-phenylene) ether and poly(2,3,6-trimethyl-1,4-phenylene) ether, and the like, and combinations thereof.

In exemplary embodiments, a copolymer of poly(2,6-dimethyl-1,4-phenylene) ether and poly(2,3,6-trimethyl-1,4-phenylene) ether and/or a copolymer of poly(2,6-dimethyl-1,4-phenylene) ether and poly(2,3,6-trimethyl-1,4-phenylene) ether may be used, for example, poly(2,6-dimethyl-1,4-phenylene) ether may be used.

Examples of the vinyl aromatic polymer may include without limitation (co)polymers of styrene, p-methylstyrene, a-methylstyrene, 4-n-propylstyrene, and the like, and combinations of two or more vinyl aromatic monomers (which can be copolymerized). In exemplary embodiments, the vinyl aromatic monomer may include styrene, a-methylstyrene, and/or a copolymer thereof.

Examples of the reactive monomer may include without limitation unsaturated carboxylic acids and/or anhydrides thereof, and/or modified unsaturated carboxylic acids and/or anhydrides thereof. Such a reactive monomer may play the role of reacting with the polyphenylene ether polymer according to an embodiment of the present invention to form a modified polyphenylene ether polymer.

Examples of the reactive monomer may include without limitation citric acid, citric acid anhydride, maleic acid anhydride, maleic acid, itaconic acid anhydride, fumaric acid, (meth)acrylic acid, (meth)acrylic acid esters, and the like, and combinations thereof.

There is no particular limitation to the method for preparing a modified polyphenylene ether polymer by reacting a polyphenylene ether polymer with a reactive monomer. In exemplary embodiments, it can be effective to graft-react a polyphenylene ether polymer with a reactive monomer, with the polyphenylene ether polymer melt and mulled using a phosphite heat stabilizer, considering the relatively high operating temperature.

There is no particular limitation to the degree of polymerization of polyphenylene ether according to an embodiment of the present invention. In exemplary embodiments, the polyphenylene ether can have an intrinsic viscosity of about 0.2 to about 0.8 dl/g when measured at a chloroform solvent of 25° C., for example, about 0.3 to about 0.6 dl/g.

The thermal resistance and mechanical strength can be excellent and thus enable easy processing when the intrinsic viscosity is within the aforementioned range.

The base resin can include the polyphenylene ether in an amount of about 10 to about 70 weight %, for example, about 20 to about 60 weight %, per 100 weight % of a base resin including the polyphenylene ether and polyamide. In some embodiments, the base resin may include the polyphenylene ether in an amount of about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, or 70 weight %. Further, according to some embodiments of the present invention, the amount of the polyphenylene ether can be in a range from about any of the foregoing amounts to about any other of the foregoing amounts.

If the polyphenylene ether is present in an amount outside the aforementioned range, a problem may occur such as deterioration of flexibility or chemical resistance, or difficulty in processing.

(a-2) Polyamide

Amino acid, lactam, or diamine and dicarboxylic acid may be the main monomer substance of polyamide (a-2).

Representative examples of the main monomer include without limitation: amino acids such as 6-aminocapronic acid, 11-aminoundecanic acid, 12-aminododecanic acid, and para aminomethylbenzoid acid; lactams such as ε-caprolactam and ω-laurolactam; aliphatic, alicyclic, and/or aromatic diamines such as tetramethylenediamine, hexamethylenediamine, 2-methylpentamethylenediamine, nonamethylenediamine, undecamethylenediamine, dodecamethylenediamine, 2,2,4-/2,4,4-trimethylhexamethylenediamine, 5-methylnonamethylenediamine, metaxylenediamine, paraxylenediamine, 1,3-bis(aminomethyl)cyclohexane, 1,4-bis(aminomethyl)cyclohexane, 1-amino-3-aminomethyl-3,5,5-trimethylcyclohexane, bis(4-aminocyclohexyl)methane, bis(3-methyl-4-aminocyclohexyl)methane, 2,2-bis(4-aminocyclohexyl)propane, bis(aminopropyl) piperazine, aminoethylpiperazine; aliphatic, alicyclic, and/or aromatic dicarboxylic acids such as adipic acid, suberic acid, azelaic acid, sebacic acid, dodecanoic acid, terephthalic acid, isophthalic acid, 2-chloroterephthalic acid, 2-methylterephthalic acid, 5-methylisophthalic acid, 5-sodium sulfoisophthalic acid, 2,6-naphthalenedicarboxylic acid, hexahydroterephthalic acid, and hexahydroisophthalic acid; and the like. A polyamide homopolymer and/or copolymer derived from the aforementioned materials may be used solely or in a mixture.

Specific examples of polyamide according to an embodiment of the present invention include without limitation polyamide 6, polyamide 66, polyamide 46, polyamide 11, polyamide 12, polyamide 610, polyamide 612, polyamide 6/66, polyamide 6/612, polyamide MXD6, polyamide 6/MXD6, polyamide 66/MXD6, polyamide 6T, polyamide 61, polyamide 6/6T, polyamide 6/61, polyamide 66/6T, polyamide 66/61, polyamide 6/6T/61, polyamide 66/6T/61, polyamide 9T, polyamide 91, polyamide 6/9T, polyamide 6/91, polyamide 66/9T, polyamide 6/12/9T, polyamide 66/12/9T, polyamide 66/12/91, polyamide 66/12/61 and the like, and combinations thereof mixed in an appropriate rate.

The melting point of the polyamide may be about 220 to about 360° C., for example about 230 to about 320° C., and as another example about 240 to about 300° C.

To provide a resin composition with excellent mechanical properties and thermal resistance, the relative viscosity of the polyamide may be or above about 2, for example about 2 to about 4. Herein, the relative viscosity may be measured at 25° C. after adding 1 weight % of polyamide to m-cresol.

The base resin may include the polyamide in an amount of about 30 to about 90 weight %, for example about 40 to about 80 weight %, per 100 weight % of base resin including polyphenylene ether and the polyamide. In some embodiments, the base resin may include the polyamide resin in an amount of about 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74 75, 76, 77, 78, 79, 80, 81, 82, 83, 84, 85, 86, 87, 88, 89, or 90 weight %. Further, according to some embodiments of the present invention, the amount of the polyamide can be in a range from about any of the foregoing amounts to about any other of the foregoing amounts.

If the polyamide is present in an amount outside the aforementioned range, a problem may occur such as deterioration of compatibility, mechanical properties, and thermal resistance.

(b) Impact Modifier

An impact modifier may play the role of improving the impact resistance of a polyamide/polyphenylene ether resin composition.

The impact modifier used herein may be styrenic elastomer (b-1), olefinic elastomer (b-2), or a combination thereof

The polyamide/polyphenylene ether resin composition may include the impact modifier in an amount of about 1 to about 30 parts by weight, for example about 5 to about 20 parts by weight, and as another example about 6 to about 15 parts by weight per about 100 parts by weight of the base resin. In some embodiments, the polyamide/polyphenylene ether resin composition may include the impact modifier in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 parts by weight. Further, according to some embodiments of the present invention, the amount of the impact modifier can be in a range from about any of the foregoing amounts to about any other of the foregoing amounts.

(b-1) Styrenic Elastomer

Examples of the styrenic elastomer (b-1) may include without limitation block copolymers including an aromatic vinyl compound and conjugated diene compound; hydrogenated block copolymers prepared by hydrogenating the block copolymer including an aromatic vinyl compound and conjugated diene compound; modified block copolymers prepared by modifying the block copolymer with an α,β-unsaturated dicarboxylic acid and/or an α,β-unsaturated dicarboxylic acid derivative; modified hydrogenated block copolymers prepared by modifying the hydrogenated block copolymer with an α,β-unsaturated dicarboxylic acid and/or an α,β-unsaturated dicarboxylic acid derivative; and the like, and combinations thereof

Examples of the aromatic vinyl compound may include without limitation styrene, p-methylstyrene, a-methylstyrene, bromostyrene, chlorostyrene, and the like, and combinations thereof. In exemplary embodiment, the aromatic vinyl compound may include styrene.

The styrenic elastomer is derived from an aromatic vinyl compound, the styrenic elastomer having a linear structure including a diblock (A-B block), triblock (A-B-A block), tetrablock (A-B-A-B block), pentablock (A-B-A-B-A block), and/or a linear structure including six or more blocks of A and B.

Specific examples of styrenic elastomer that may be used include without limitation a styrene-ethylene-butylene-styrene copolymer, styrene-butadiene-styrene copolymer, styrene-ethylene-propylene-styrene copolymer, styrene-isoprene-styrene copolymer, styrene-ethylene copolymer, and/or styrene-ethylene-butadiene-styrene copolymer; and/or a modified styrenic elastomer including without limitation modified styrene-ethylene-butylene-styrene copolymer, modified styrene-butadiene-styrene copolymer, modified styrene-ethylene-propylene-styrene copolymer, modified styrene-isoprene-styrene copolymer, modified styrene-ethylene copolymer, and/or modified styrene-ethylene-butadiene-styrene copolymer, wherein each modified styrenic elastomer is prepared by modifying one of the aforementioned non-modified styrenic elastomer with an α,β-unsaturated dicarboxylic acid and/or an α,β-unsaturated dicarboxylic acid derivative. In some cases, two or more of the aforementioned may be used. In exemplary embodiments, styrene-ethylene-butylene-styrene copolymer can be used.

(b-2) Olefinic Elastomer

Examples of the olefinic elastomer (b-2) may include without limitation: high-density polyethylene, low-density polyethylene, linear low-density polyethylene, ethylene-α-olefin copolymer, and the like, and combinations thereof and/or a modified olefinic elastomer including without limitation modified high-density polyethylene, modified low-density polyethylene, modified linear low-density polyethylene, and/or modified ethylene-α-olefin copolymer, wherein each modified olefinic elastomer is prepared by modifying one of the aforementioned non-modified olefinic elastomers with an α,β-unsaturated dicarboxylic acid and/or an α,β-unsaturated dicarboxylic acid derivative.

The olefinic elastomer may be a (co)polymer polymerized using an olefinic monomer(s) and/or a copolymer of the olefinic monomer and an acrylic monomer.

The olefinic monomer used may include a C1-C19 alkylene, for example, ethylene, propylene, isopropylene, butylene, isobutylene, octene, or a combination thereof.

The acrylic monomer used may be a (meth) acrylic acid alkyl ester and/or (meth) acrylic acid ester. As used herein, the alkyl may be C1-C10 alkyl. Examples of the (meth) acrylic acid alkyl ester that may be used include without limitation methyl(meth)acrylate, ethyl(meth)acrylate, propyl(meth)acrylate, and/or butyl(meth)acrylate, for example methyl(meth)acrylate.

The olefinic elastomer may include a reactive group that may react with polyamide, and the olefinic elastomer may have a structure where a reactive group is grafted to a main chain including an olefinic monomer or a copolymer of the olefin monomer and an acrylic monomer.

Examples of the reactive group may include without limitation a maleic acid anhydride group and/or an epoxy group.

In an embodiment, the olefinic elastomer including a reactive group may include without limitation a modified ethylene-α-olefin copolymer and/or modified low-density polyethylene grafted with a maleic acid anhydride. Such an olefinic elastomer can improve the compatibility of polyphenylene ether and polyamide.

(c) Compatibilizer

Compatibilizer (c) may be a compound including two types of functional groups, or a compound modified to a compound including two types of functional groups when reacted. Examples of one of the two types of functional groups may include without limitation a double carbon bond and/or a triple carbon bond. Examples of the other of the two types of functional groups may include without limitation a carboxylic group, acid anhydride group, epoxy group, imide group, amide group, ester group, and/or a functional group of acidic chloride or effective equivalent thereof. Specific examples of the compatibilizer that may be used include without limitation maleic acid, maleic acid anhydride, fumaric acid, maleic hydrazide, dichloro maleic acid anhydride, unsaturated dicarboxylic acid, citric acid, citric acid anhydride, malic acid, agaric acid and the like, and combinations thereof. In some cases, two or more of the aforementioned may be used.

In exemplary embodiments, examples of the compatibilizer include without limitation maleic acid, maleic acid anhydride, fumaric acid, citric acid, and/or citric acid anhydride, for example maleic anhydride and/or citric anhydride.

When the compatibilizer and/or a modified compatibilizer reacts with polyphenylene ether and polyamide, a block copolymer of polyphenylene ether and polyamide may be generated.

In the polyamide/polyphenylene ether resin composition, the block copolymer can be distributed along an interface of the two substances, thus stabilizing the morphology of the resin composition. Especially, in a case where the polyamide/polyphenylene ether resin composition has a morphology where the polyphenylene ether has a domain phase (dispersed phase) and the polyamide has a matrix phase (continuous phase), the block copolymer seems to play an important role in controlling the particle diameter of the domain phase to an effective about 1 μm (Polymer Engineering and Science, 1990, vol. 30, No. 17, p. 1056-1062).

The polyamide/polyphenylene ether resin composition may include the compatibilizer in an amount of about 0.2 to about 10 parts by weight per about 100 parts by weight of base resin. In some embodiments, the polyamide/polyphenylene ether resin composition may include the compatibilizer in an amount of about 0.2, 0.3, 0.4, 0.5, 0.6, 0.7, 0.8, 0.9, 1, 2, 3, 4, 5, 6, 7, 8, 9, or 10 parts by weight. Further, according to some embodiments of the present invention, the amount of the compatibilizer can be in a range from about any of the foregoing amounts to about any other of the foregoing amounts.

When the compatibilizer constitutes less than about 0.2 parts by weight per about 100 parts by weight of the base resin, there can be little effect of improving the impact strength, and when the compatibilizer constitutes more than about 10 parts by weight per about 100 parts by weight of the base resin, the impact strength may not increase any more, and other properties can deteriorate as well.

(d) Electroconductive Filler

Electroconductive filler (d) may be dispersed in the polyamide/polyphenylene ether composition, providing electroconductivity.

Examples of the electroconductive filler may include without limitation at least one of carbon black and/or carbon fibril.

There is no limitation to the type of the carbon black, but an electroconductive carbon black may be used. Specific examples that may be used include graphitized carbon black, furnace black, acetylene black, and/or ketjen black.

Carbon fibril is a carbon material in the form of fiber where carbon accounts for 90 weight % or more of the total mass.

An example of the carbon fibril that may be used herein is carbon nanotube. Carbon nanotubes have a large aspect ratio and a large specific surface area, and also excellent mechanical properties, electric properties, and thermal properties, and thus it is an effective material to be used as an engineering plastic material.

Carbon nanotubes may be classified into single wall, double wall, and multiple wall carbon nanotubes depending on the number of walls that carbon nanotubes are composed of. Furthermore, they may be classified into zigzag, armchair, and chiral structured carbon nanotubes depending on the angle by which a graphene surface is curled. There is no limitation to the type or structure of the carbon nanotubes used herein. In exemplary embodiments, multiple wall nanotubes may be used.

There is no particular limitation to the size of the carbon nanotubes that may be used herein. In exemplary embodiments, the diameter of the carbon nanotubes may be about 0.5 to about 100 nm, for example about 1 to about 10 nm, and the length may be about 0.01 to about 100 nm, for example about 0.5 to about 10 μm. Carbon nanotubes can provide excellent electroconductivity and processibility when the diameter and length are within the aforementioned range.

Furthermore, due to the aforementioned size, the carbon nanotubes have large aspect ratios (L/D). The carbon nanotubes can have an aspect ratio of about 100 to about 1,000 L/D, which can provide excellent electroconductivity.

Electroconductive fillers such as carbon black and/or carbon fibril in an embodiment of the present invention may have a pH of about 4 to about 8, for example about 4.5 to about 7.5.

By adjusting the pH of the electroconductive filler in providing electroconductivity to the polyamide/polyphenylene ether resin composition, it is possible to resolve the problem of compatibility between polyamide and polyphenylene ether being reduced due to the electroconductive filler while significantly improving the electroconductivity.

Carbon black and carbon nanotubes generally have a pH of about 9. Due to such a high pH, compatibilizers and reactants such as maleic acid and citric acid may be generated that may deteriorate the functions of the compatibilizers, thus restricting compatibilization of the polyphenylene ethylene and polyamide.

An electroconductive filler having a pH of about 4 to about 8 may be obtained through a neutralization or acidification process.

The polyamide/polyphenylene ether resin composition may include electroconductive filler in an amount of about 0.1 to about 3.5 parts by weight, for example about 0.3 to about 3.0 parts by weight, per about 100 parts by weight of the base resin. In some embodiments, the polyamide/polyphenylene ether resin composition may include the electroconductive filler in an amount of about 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4 or 3.5 parts by weight. Further, according to some embodiments of the present invention, the amount of the electroconductive filler can be in a range from about any of the foregoing amounts to about any other of the foregoing amounts.

Excellent electroconductivity and impact resistance may be provided when the electroconductive filler is present in an amount within the aforementioned range. When the amount of the electroconductive filler is less than about 0.1 parts by weight per about 100 parts by weight of base resin, the electroconductivity of the electroconductive polyamide/polyphenylene ether resin composition can decrease, and thus may not be suitable for electrostatic painting. When the amount of the electroconductive filler is more than about 3.5 parts by weight per about 100 parts by weight of base resin, the impact strength may decrease and economically not feasible.

Besides the aforementioned, the electroconductive polyamide/polyphenylene ether resin composition may further include one or more additives such as but not limited to flame retardant, lubricant, plasticizer, heat stabilizer, antioxidant, light stabilizer, colorant, inorganic filler, and the like. Depending on the characteristics of a final molded product, two or more of the aforementioned additives may be used.

A flame retardant is a material that reduces combustibility. Examples of the flame retardant may include without limitation phosphate compounds, phosphite compounds, phosphonate compounds, polysiloxanes, phosphazene compounds, phosphinate compounds, melamine compounds, and the like, and combinations thereof

The lubricant is a material for lubricating the interface of a resin composition between a metal surface that contacts the electroconductive polyamide/polyphenylene ether resin composition during processing, molding, and extruding, thereby helping the flow or movement of the resin composition. Herein, a generally used lubricant may be used.

A plasticizer is a material for improving the flexibility, processibility, and expansibility of the electroconductive polyamide/polyphenylene ether resin composition. Herein, a generally used plasticizer may be used.

A heat stabilizer is a material for restraining thermal decomposition of the polyamide/polyphenylene ether resin composition when being mulled and molded at high temperatures. A generally used material may be used as heat stabilizer.

An antioxidant is a material for restraining or preventing chemical reaction of the electroconductive polyamide/polyphenylene ether resin composition with oxygen, thus preventing the resin composition from being decomposed and losing its intrinsic properties. Examples of the antioxidant may include without limitation phenolic type antioxidants, phosphate type antioxidants, thioether type antioxidants, amine type antioxidant antioxidants, and the like, and combinations thereof

A light stabilizer is a material for restraining or preventing the electroconductive polyamide/polyphenylene ether resin composition from being decomposed by ultraviolet rays or losing its mechanical properties. In exemplary embodiments, titanium oxide may be used as an antioxidant.

Examples of the colorant may include without limitation pigments and/or dyes.

The polyamide/polyphenylene ether resin composition may include one or more additives in an amount of about 0.1 to about 10 parts by weight per about 100 parts by weight of the base resin. If the additive(s) are present in an amount outside this range, the mechanical properties of the electroconductive polyamide/polyphenylene ether resin composition can deteriorate or the surface appearance of a product molded using the resin composition may become defective.

The electroconductive polyamide/polyphenylene ether resin composition according to an embodiment of the present invention may well be prepared by a well known method. In exemplary embodiments, the resin composition may be prepared by a method including: preparing an electroconductive polyphenylene ether mixture composition by melting and mulling (mixing) polyphenylene ether (a-1), impact modifier (b), compatibilizer (c) and electroconductive filler (d); forming a polyphenylene ether-polyamide mixture composition by adding polyamide (a-2) to the polyphenylene ether composition; and melting and mulling (mixing) the polyphenylene-polyamide mixture composition.

Details of each component are as explained hereinabove regarding the polyamide/polyphenylene ether resin composition.

In conventional methods, since electroconductive fillers make compatibilization of polyphenylene ether and polyamide difficult, electroconductive polyamide/polyphenylene ether resin compositions can be prepared by compatibilizing the polyphenylene ether and polyamide first by mulling the polyphenylene ether and polyamide, and then adding the electroconductive filler.

However, according to embodiments of the present invention, an electroconductive filler having a pH of about 4 to about 8 does not affect forming a compatibilized blend even when added before the compatibilization of polyphenylene ether and polyamide, and thus it is possible to embody an electroconductive polyamide/polyphenylene ether resin composition having excellent properties in pellet forms by mixing the aforementioned components and additives, and then mulling and extruding the same in an extruder.

That is, it has become possible to simplify the process by adjusting the pH of the electroconductive filler, and using certain substances and adjusting the contents thereof

A molded product for vehicles may be prepared using the aforementioned electroconductive polyamide/polyphenylene ether resin composition. The aforementioned electroconductive polyamide/polyphenylene ether resin composition can have excellent electroconductivity and impact resistance, and thus may be used in, without limitation, automobile components such as tail gates, fuel doors, fenders, door panels etc.

The molded product for vehicles can have excellent impact resistance and electroconductivity, for example, an Izod impact strength of about 15 to about 35 kJ/m², and a surface resistance of about 1×10⁴ to about 8×10⁶Ω/□.

### EXAMPLES

Hereinafter, a result of an experiment conducted to prove the excellent effects of the electroconductive polyamide/polyphenylene ether resin composition of the present invention will be shown.

Components used in the electroconductive polyamide/polyphenylene ether resin composition according to the embodiments and comparative embodiments of the present invention are as shown below.

(a) Base Resin

(a-1) Polyphenylene Ether

Poly(2,5-dimethyl-1,4-phenylene) ether having an intrinsic viscosity of 0.46 dl/g of Asahi Kasei Chemicals Corp. is used.

(a-2) Polyamide

TECHNYL 24 FE 1, a polyamide 66 product of Rhodia Co., is used.

(b) Impact Modifier

(b-1) Styrenic Elastomer

KRATON G 1651, a styrene-ethylene-butylene-styrene copolymer of KRATON Polymers Co., is used.

(b-2) Olefinic Elastomer

A maleic anhydride modified ethylene-propylene copolymer is used.

(c) Compatibilizer

Citric acid anhydride of Sigma-Aldrich Co. is used.

(d) Electroconductive filler

(d-1) An electroconductive carbon black having a pH of 7 prepared by neutralizing, with acetic acid, EC-600JD, a ketjen black product of Akzo Nobel Co., is used.

(d-2) An electroconductive carbon black having a pH of 3.5 prepared by acidifying, with acetic acid, EC-600JD, a ketjen black product of Akzo Nobel Co., is used.

(d-3) EC-600JD, a ketjen black product and electroconductive carbon black having a pH of 9 of Akzo Nobel Co., is used.

(d-4) An electroconductive carbon fibril having a pH of 7.2 is used.

An electroconductive polyamide/polyphenylene ether resin composition according to embodiments and comparative examples of the present invention is prepared according to the substance ratios listed in table 1.

The substances listed in ‘main feed’ in table 1 are dry-mixed, and then continuously input quantitatively into a main feeding port of a twin-screw extruder TEX-40 (manufacturer: JSW Co.). The substances listed in ‘side feed’ in table 1 are continuously input quantitatively into a side feeding port of the twin-screw extruder, and then melted/mulled. Herein, the screw rotation speed of the extruder is 400 rpm, and the total production speed is 100 kg per hour. Then, a resin composition pelletized by the extruder is obtained.

Herein, the side feeding port refers to the port located close to the die of the extruder.

The base resins a-1 and a-2 combined are 100 parts by weight, based on the parts by weight as shown.

TABLE 1

| | | | | | Comparative | |
|---|---|---|---|---|---|---|
| | | Embodiments | | | examples | |
| | Substances | 1 | 2 | 3 | 1 | 2 |
| Main feed | a-1 | 40 | 40 | 40 | 40 | 40 |
| | b-1 | 6 | 6 | 6 | 6 | 6 |
| | b-2 | — | 5 | 5 | — | — |
| | c | 0.8 | 0.8 | 0.8 | 0.8 | 0.8 |
| | d-4 | — | — | 1 | — | — |
| Side feed | d-1 | 3 | — | — | — | — |
| | d-2 | — | — | — | 3 | — |
| | d-3 | — | — | — | — | 3 |
| | d-4 | — | 1 | — | — | — |
| | a-2 | 60 | 60 | 60 | 60 | 60 |

Izod impact strengths and surface resistances of polyamide/polyphenylene ether resin compositions of embodiments 1 to 3 and comparative examples of 1 to 2 are evaluated according to the methods described below. Results of the evaluations are listed in table 2.

<Izod Impact Strength>

After injection-molding electroconductive polyamide/polyphenylene ether resin composition pellets of embodiments 1 to 3 and comparative examples 1 to 2 into type A multipurpose specimens according to ISO 3167, both end taps of each specimen are cut by a size of 80 mm×10 mm×4 mm, and a notch with a depth of 8 mm is made in the specimen, and then Izod impact strength is measured according to ISO 180/1A. The average value of the measurement results of ten specimens is used as the estimation result.

<Surface Resistance>

Specimens for surface resistance measurement are prepared by thermal compression molding. After putting about 6 g of pellets of the electroconductive polyamide/polyphenylene ether resin compositions of embodiments 1 to 3 and comparative examples 1 to 2 into a mold having a cavity of 100 mm×100 mm×0.5 mm, the mold is placed between a pair of metal plates, and then the mold is inserted into a thermal compression molding machine set to 300° C. After applying 50 kg/cm² of pressure to the mold and the metal plate for 3 minutes, the mold and the metal plate are taken out of the thermal compression molding machine and then inserted into a cooling compression molding machine set to 25° C. After applying 50 kg/cm² of pressure to the mold and the metal plate for 2 minutes, the mold and metal plate are taken out from the cooling compression molding machine, and then a specimen of 100 mm×100 mm×0.5 mm is separated from the mold and the pair of metal plates in order to measure the surface resistance. The compression molded specimens are conditioned at a temperature of 23° C. and a relative humidity of 50% for 6 hours.

Surface resistances of the polyamide/polyphenylene ether resin compositions of embodiments 1 to 3 and comparative examples 1 to 2 are measured at a temperature of 23° C. and a relative humidity of 50% using Hiresta-UP MCP-HT450, which is a resistance measurement system having a probe MCP-HTP14 made by Mitsubishi Chemical Analytech Co. During the measurement process, 250V voltage is maintained for 30 seconds.

TABLE 2

| | | | | Comparative | |
|---|---|---|---|---|---|
| | Embodiments | | | examples | |
| | 1 | 2 | 3 | 1 | 2 |
| Izod impact | 25 | 26 | 22 | 7 | 5 |
| strength | | | | | |
| (kJ/m²) | | | | | |
| Surface | 1 × 10⁶ | 2 × 10⁶ | 5 × 10⁶ | 2 × 10⁷ | 1 × 10⁷ |
| resistance | | | | | |
| (Ω/□) | | | | | |

From tables 1 and 2, it can be seen that the electroconductive polyamide/polyphenylene ether resin compositions of embodiments 1 to 3 may maintain excellent levels of impact strength and electroconductivity.

Especially, embodiment 1 that used a carbon black having neutrality of pH 7 shows excellent results with excellent Izod impact strength and low surface resistance measured.

In comparison, in light of the high surface resistances that reduced the electroconductivity and impact strength in comparative examples 2 and 3, it can be seen that the pH of an electroconductive filler may be a variable in providing an improved electroconductivity to the polyamide/polyphenylene ether resin composition and maintaining the excellent impact strength.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims. Therefore, the aforementioned embodiments should be understood to be exemplary but not limiting the present invention in any way.

What is claimed is:

1. An electroconductive polyamide/polyphenylene ether resin composition comprising:
a base resin (a) including polyphenylene ether (a-1) and polyamide (a-2);
an impact modifier (b);
a compatibilizer (c); and
an electroconductive filler (d) having a pH of about 4 to about 8.

2. The composition according to claim 1,
wherein the base resin (a) comprises:
about 10 to about 70 weight % of polyphenylene ether (a-1) and about 30 to about 90 weight % of polyamide (a-2), and
wherein the composition comprises about 1 to about 30 parts by weight of impact modifier (b), about 0.2 to about 10 parts by weight of compatibilizer (c), and about 0.1 to about 3.5 parts by weight of electroconductive filler (d), per about 100 parts by weight of the base resin (a).

3. The composition according to claim 1, wherein the electroconductive filler (d) comprises carbon black and/or carbon fibril.

4. The composition according to claim 1, wherein the electroconductive filler (d) has a pH of about 4.5 to about 7.5.

5. The composition according to claim 2, wherein the composition comprises the electroconductive filler (d) in an amount of about 0.3 to about 3 parts by weight per about 100 parts by weight of the base resin.

6. The composition according to claim 1, wherein the electroconductive filler (d) is obtained by a neutralizing or acidifying process.

7. The composition according to claim 1, wherein the polyphenylene ether (a-1) comprises poly(2,6-dimethyl-1,4-phenylene) ether, poly(2,6-diethyl-1,4-phenylene) ether, poly(2,6-dipropyl-1,4-phenylene) ether, poly(2-methyl-6-ethyl-1,4-phenylene) ether, poly(2-methyl-6-propyl-1,4-phenylene) ether, poly(2-ethyl-6-propyl-1,4-phenylene) ether, poly(2,6-diphenyl-1,4-phenylene) ether, a copolymer of poly(2,6-dimethyl-1,4-phenylene) ether and poly(2,3,6-trimethyl-1,4-phenylene) ether, a copolymer of poly(2,6-dimethyl-1,4-phenylene) ether and poly(2,3,6-triethyl-1,4-phenylene) ether or a combination thereof.

8. The composition according to claim 1, wherein the polyamide (a-2) comprises polyamide 6, polyamide 66, polyamide 46, polyamide 11, polyamide 12, polyamide 610, polyamide 612, polyamide 6/66, polyamide 6/612, polyamide MXD6, polyamide 6/MXD6, polyamide 66/MXD6, polyamide 6T, polyamide 61, polyamide 6/6T, polyamide 6/61, polyamide 66/6T, polyamide 66/61, polyamide 6/6T/61, polyamide 66/6T/61, polyamide 9T, polyamide 91, polyamide 6/9T, polyamide 6/91, polyamide 66/9T, polyamide 6/12/9T, polyamide 66/12/9T, polyamide 6/12/91, polyamide 66/12/61 or a combination thereof.

9. The composition according to claim 1, wherein the impact modifier (b) comprises styrenic elastomer (b-1) and/or olefinic elastomer (b-2).

10. The composition according to claim 9, wherein the styrenic elastomer (b-1) comprises styrene-ethylene-butylene-styrene copolymer, styrene-butadiene-styrene copolymer, styrene-ethylene-propylene-styrene copolymer, styrene-isoprene-styrene copolymer, styrene-ethylene copolymer, styrene-ethylene-butadiene-styrene copolymer, modified styrene-ethylene-butylene-styrene copolymer, modified styrene-butadiene-styrene copolymer, modified styrene-ethylene-propylene-styrene copolymer, modified styrene-isoprene-styrene copolymer, modified styrene-ethylene copolymer, modified styrene-ethylene-butadiene-styrene copolymer or a combination thereof, wherein the modified copolymers are each prepared by modifying the styrene-ethylene-butylene-styrene copolymer, styrene-butadiene-styrene copolymer, styrene-ethylene-propylene-styrene copolymer, styrene-isoprene-styrene copolymer, styrene-ethylene copolymer, or styrene-ethylene-butadiene-styrene copolymer, respectively, with an α,β-unsaturated dicarboxylic acid and/or an α,β-unsaturated dicarboxylic acid derivative.

11. The composition according to claim 9, wherein the olefinic elastomer (b-2) comprises high-density polyethylene, low-density polyethylene, linear low-density polyethylene, ethylene-α-olefin copolymer, modified high-density polyethylene, modified low-density polyethylene, modified linear low-density polyethylene, modified ethylene-α-olefin copolymer or a combination thereof, wherein the modified compounds are each prepared by modifying the high-density polyethylene, low-density polyethylene, linear low-density polyethylene, or ethylene-α-olefin copolymer, respectively, with an α,β-unsaturated dicarboxylic acid and/or α,β-unsaturated dicarboxylic acid derivative.

12. The composition according to claim 1, wherein the compatibilizer (c) comprises maleic acid, maleic acid anhydride, maleic acid hydrazide, dichloromaleic acid anhydride, unsaturated dicarboxylic acid, fumaric acid, citric acid, citric acid anhydride, malic acid, agaric acid or a combination thereof.

13. A molded product for vehicles, the product manufactured from an electroconductive polyamide/polyphenylene ether resin composition of claim 1.

14. A method for preparing an electroconductive polyamide/polyphenylene ether resin composition, the method comprising:
preparing an electroconductive polyphenylene ether mixture composition by melting and mulling polyphenylene ether (a-1), impact modifier (b), compatibilizer (c) and electroconductive filler (d);
forming a polyphenylene ether-polyamide mixture composition by adding polyamide (a-2) to the polyphenylene ether mixture composition; and
melting and mulling the polyphenylene-polyamide mixture composition.

15. The method according to claim 14, wherein the electroconductive filler (d) has a pH of about 4 to about 8.

16. The method according to claim 14, wherein the electroconductive filler (d) comprises carbon black and/or carbon fibril.

17. The method according to claim 14, wherein the electroconductive filler (d) is obtained by a neutralizing or acidifying process.
